(19) United States
(12) Patent Application Publication
(10) Pub. No.: US 2003/0037980 A1
(43) Pub. Date: Feb. 27, 2003

(54) Power device of scooter

(75) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(73) Assignee: J.D. COMPONENTS CO., LTD., Chang Hua Hsien (TW)

(21) Appl. No.: 09/932,995

(22) Filed: Aug. 21, 2001

(51) Int. Cl. B62M 7/00; B62D 61/02

(52) U.S. Cl. 180/220

(57) ABSTRACT

A power device of the scooter comprises a motor, an elastic member, and a one-way bearing. The motor is mounted over the rear fork of the scooter footboard and is provided with a transmission shaft on which a drive wheel is mounted. The elastic member is fastened at two ends with the footboard of the scooter for forcing the drive wheel to press intimately against the rear wheel of the scooter. The one-way bearing is disposed on the transmission shaft such that the one-way bearing is received in the drive wheel for providing a one-way clutching effect, thereby enabling the drive wheel to receive the power of the motor in a predetermined manner so as to drive the rear wheel of the scooter. When the motor is stopped, the rear wheel is hauled to rotate on its own.

### FIELD OF THE INVENTION

The present invention relates generally to a scooter, and more particularly to a power device of the scooter.

### BACKGROUND OF THE INVENTION

The conventional scooter generally comprises a lower and narrow footboard with a wheel at each end, and a raised handlebar for steering. The scooter is moved by a series of pushes made by one foot of a rider against the ground. It is conceivable that the rider of the conventional scooter becomes physically exhausted after a prolonged ride. With a view to providing a remedy, this inventor of the present invention discloses a scooter power clutch mechanism. As shown in FIG. 1, this scooter power clutch mechanism 20 comprises a suspension seat 21 pivoted with the scooter footboard 12, a motor 22 mounted on the suspension seat 21, and a drive wheel 23 mounted on a transmission shaft 221 of the motor 22 such that the drive wheel 23 is in contact with a rear wheel 18 of the scooter. The scooter rear wheel 18 is driven by the drive wheel 23 to move the scooter forward. An elastic member 24 is fastened at two ends with the suspension seat 21 and a rear fork 17 of the footboard 12 of the scooter. An urging member 25 is fastened pivotally at one end with the rear fork 17, and at other end with the suspension seat 21 such that the other end of the urging member 25 can be detached from the suspension seat 21. When the urging member 25 urges the suspension seat 21, the drive wheel 23 is separated from the rear wheel 18. When the urging member 25 does not urge the suspension seat 21, the drive wheel 23 is in an intimate contact with the rear wheel 18.

In the course of operating the power clutch mechanism 20, the operator must rely on a manual or auxiliary member to turn the urging member 25 such that the drive wheel 23 comes in contact with the rear wheel 18. It is readily apparent that the prior art power clutch mechanism 20 can not be easily operated, and that the power switch can not be effected with precision after a prolonged operation of the power clutch mechanism 20.

### SUMMARY OF THE INVENTION

The primary objective of the present invention is to provide a scooter with a power device which is free of the deficiencies of the prior art scooter power clutch mechanism described above.

In keeping with the principle of the present invention, the foregoing objective of the present invention is attained by a scooter power device comprising a motor, and an elastic member. The motor is mounted at one end of the scooter footboard and is provided with a power transmission shaft on which a drive wheel is mounted such that the drive wheel is in contact with the scooter rear wheel. The elastic member is connected at both ends thereof with the footboard of the scooter. The spring force of the elastic member forces the drive wheel to be in an intimate contact with the rear wheel. The present invention is characterized by the power transmission shaft of the motor, which is provided with a one-way bearing to facilitate the mounting of the drive wheel. The one-way bearing is disposed in the drive wheel to provide a one-way cluth function enabling the drive wheel to receive the power transmission of the motor in a one-way rotation fashion, thereby enabling the power transmission shaft of the motor in operation to actuate the drive wheel so as to drive the rear wheel rapidly. The drive wheel in motion is hauled to turn on its own even on the heels of cessation of the operation of the motor.

The features of the present invention will be more readily understood upon a thoughtful deliberation of the following detailed description of the present invention with reference to the accompanying drawings.

### BRIEF DESCRIPTION OF THE DRAWINGS

FIG. 1 shows a side view of a scooter power device of the prior art.

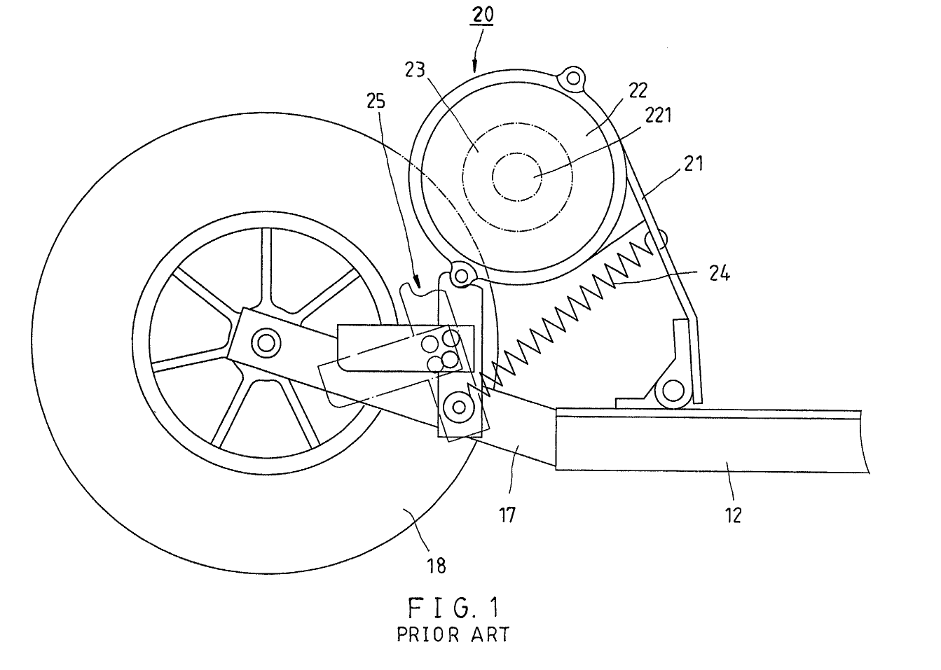

FIG. 2 shows an exploded view of a preferred embodiment of the present invention.

FIG. 3 shows a perspective view of the preferred embodiment of the present invention combination.

FIG. 4 shows a perspective view of the preferred embodiment of the present invention which is mounted on a scooter rear wheel.

FIG. 5 shows an enlarged schematic view of the preferred embodiment of the present invention which is mounted on the scooter rear wheel.

FIG. 6 shows a sectional schematic view of a portion taken along a line 6-6 as shown in FIG. 3.

### DETAILED DESCRIPTION OF THE INVENTION

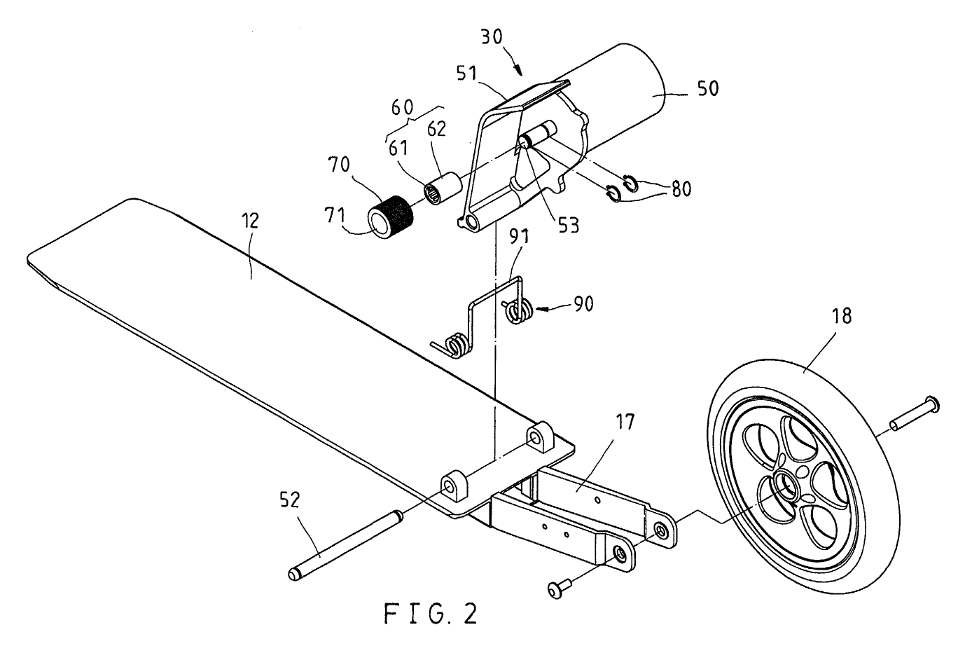

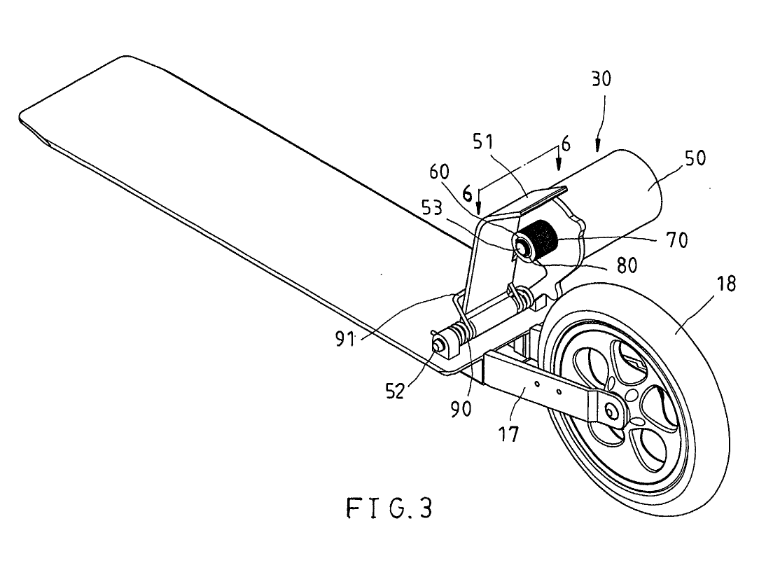

As shown in FIGS. 2-4, a power device 30 of the preferred embodiment of the present invention is mounted on a scooter 10 which comprises a footboard 12, a handlebar frame 13 pivoted to the front end of the footboard 12 and provided with a handle 11 connected with a brake cable 14, a front wheel 15 pivoted to the bottom end of the handlebar frame 13, a rear fork 17 extending from the rear end of the footboard 12, a rear wheel 18 pivoted to the rear fork 17. The power device 30 is mounted between the rear fork 17 and the rear wheel 18 and is formed of a motor 50, a one-way bearing 60, a drive wheel 70, two C-shaped rings 80, and an elastic member 90.

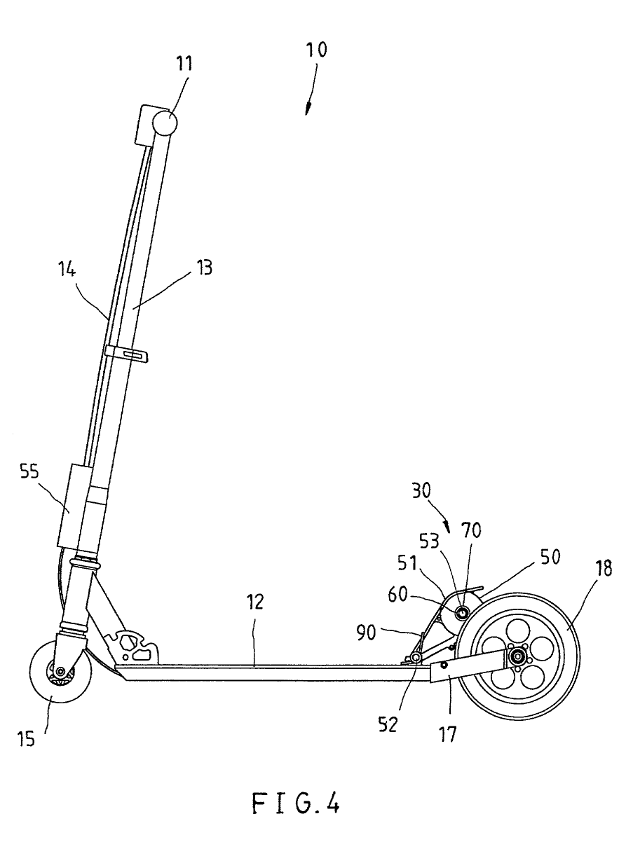

The motor 50 is connected with a fixation seat 51 which is pivoted to the longitudinal rear end of the footboard 12 by means of a pivoting rod 52 such that the motor is located over the rear fork 17 of the footobard 12. The motor 50 has a transmission shaft 53 parallel to the axle 181 of the rear wheel 18 for transmitting the power. The motor 50 is controlled by a switch device 55 which is disposed on the handlebar frame 13 of the scooter 10, as shown in FIG. 4. The motor 50 is turned on or off by the switch device 55.

The one-way bearing 60 is disposed on the transmission shaft 53 of the motor 50 for fitting with the drive wheel 70. The bearing 60 comprises an inner ring 61 and an outer ring 62, which work together to provide a one-way clutching effect. The inner ring 61 is a close fit with the transmission shaft 53, whereas the outer ring 62 is a close fit with the drive wheel 70, thereby enabling the drive wheel 70 to receive the transmission power of the motor 50 in a one-way rotational manner.

The drive wheel 70 has an axial hole 71 for fitting on the outer ring 62 of the one-way bearing 60 and for connecting with the outer ring 62 of the one-way bearing 60. The drive wheel 70 has a serrated edge which presses against the outer peripheral edge of the rear wheel 18. As the motor 50 is started, the drive wheel drives the rear wheel 18 to turn.

The two C-shaped rings 80 are disposed on the transmission shaft 53 of the motor 50 and are located at two ends of the drive wheel 70 for confining the one-way bearing 60 and the drive wheel 70, so as to enable the drive wheel 70 to press against the rear wheel 18 to drive the rear wheel 18 to turn.

The elastic member 90 is a torsion spring having a body 91 of an inverted U-shaped construction. The two ends of the elastic member 90 are disposed on the rear end of the footboard 12 of the scooter 10. The body 91 presses against the fixation seat 51 of the motor 50. The spring force of the elastic member 90 enables the motor 50 to deflect in the direction toward the rear wheel 18, so as to force the drive wheel 70 to engage intimately the rear wheel 18.

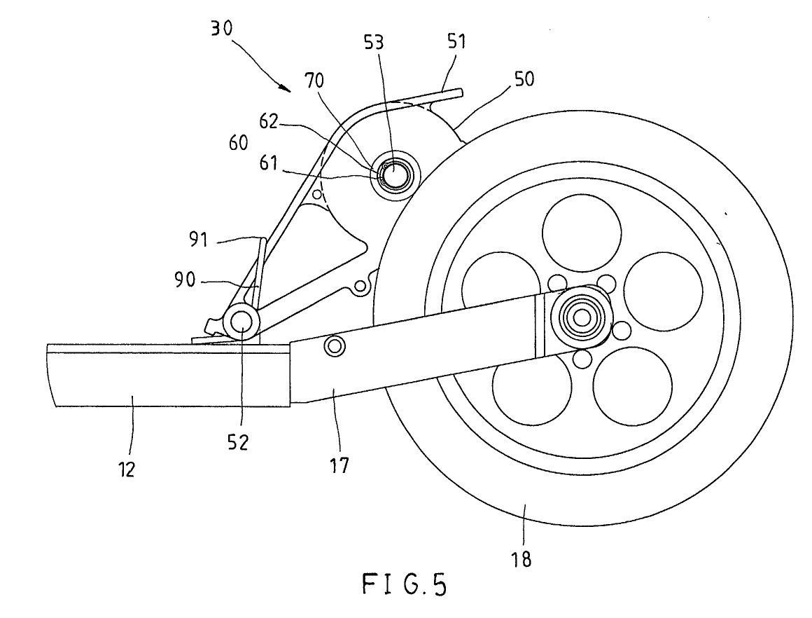

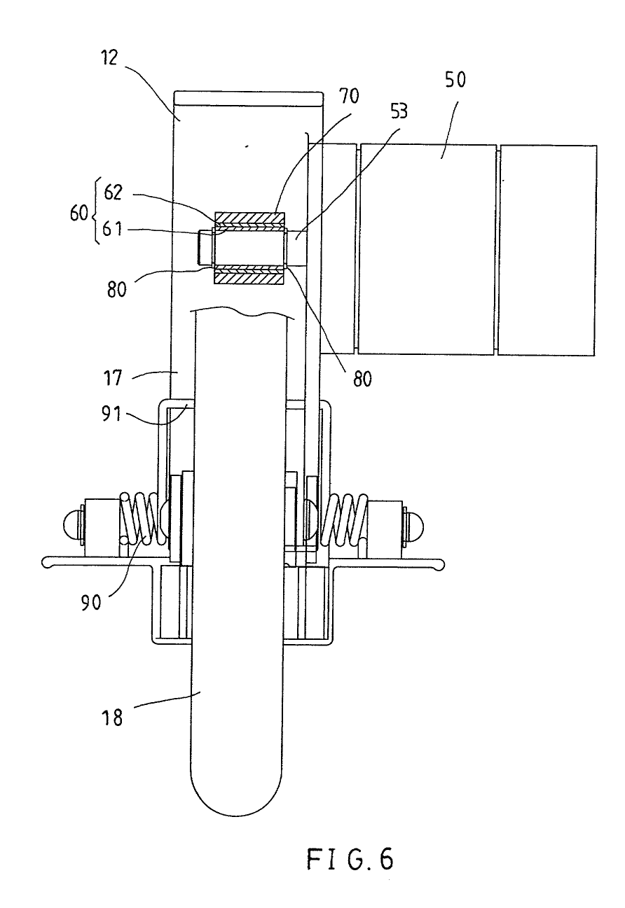

As shown in FIGS. 5 and 6, when the power device 30 is in operation, the power of the motor 50 is transmitted by the transmission shaft 53 to the drive wheel 70 via the inner ring 61 and the outer ring 62 of the one-way bearing 60. As a result, the rear wheel 18 of the scooter 10 is driven continuously by the drive wheel 70 to move the scooter 10 forward. The power is kept in the stable state.

When the motor 50 of the power device 30 is stopped, the outer ring 62 of the one-way bearing 60 continues turning. As a result, the drive wheel 70 also continues turning. In spite of the rear wheel 18 being pressed against by the drive wheel 70, the rear wheel 18 can turn. Even if the power device 30 of the scooter 10 is not transmitting the power, the scooter 10 can be moved forward by a series of pushes made by the foot of a rider of the scooter 10.

The embodiment of the present invention described above is to be regarded in all respects as being merely illustrative and not restrictive. Accordingly, the present invention may be embodied in other specific forms without deviating from the spirit thereof. The present invention is therefore to be limited by the scopes of the following claims.

What is claimed is:

1. A power device of a scooter, said power device comprising:
a motor mounted at one end of a footboard of the scooter to serve as a power source, said motor having a transmission shaft for transmitting the power;
a drive wheel mounted on said transmission shaft such that the outer peripheral edge of said drive wheel presses against the outer peripheral edge of a rear wheel of the scooter, so as to drive the rear wheel to turn;
an elastic member disposed on a rear end of the footboard of the scooter such that the spring force of said elastic member forces said drive wheel to press intimately against the outer peripheral edge of the rear wheel;
wherein said transmission shaft of said motor and said drive wheel are provided therebetween with a one-way bearing which is formed of an inner ring and an outer ring, with said inner ring being fitted close over said transmission shaft, and with said outer ring being inserted into an axial hole of said drive wheel, said one-way bearing enabling said drive wheel to receive the power of said motor in a one-way rotational manner at the time when the motor is started to transmit the power.

2. The power device as defined in claim 1, wherein said drive wheel is mounted on said transmission shaft of said motor in conjunction with two C-shaped rings located at the two ends of said drive wheel to prevent said drive wheel from moving in the axial direction of said transmission shaft.

3. The power device as defined in claim 1, wherein said motor is mounted on a fixation seat which is pivoted to a longitudinal rear end of the footboard by a pivoting shaft such that said motor is located over the rear fork of the footboard.

4. The power device as defined in claim 1, wherein said elastic member is a torsion spring of an inverted U-shaped construction.

5. The power device as defined in claim 1, wherein said drive wheel is provided in the outer peripheral edge with an annular edge of a serrated construction.

6. The power device as defined in claim 1, wherein said motor has a switch device which is disposed on a handlebar frame of the scooter for turning said motor on or off.
